(19) United States
(12) Patent Application Publication
(10) Pub. No.: US 2012/0050165 A1
(43) Pub. Date: Mar. 1, 2012

(54) KEYBOARD PAD FOR TOUCH SCREEN

(75) Inventors: Hyun Jun Kim, Gyunggi-do (KR); Yong Soo Oh, Gyunggi-do (KR); Jong Young Lee, Gyunggi-do (KR)

(73) Assignee: SAMSUNG ELECTRO-MECHANICS CO., LTD., Gyunggi-do (KR)

(21) Appl. No.: 12/954,825

(22) Filed: Nov. 26, 2010

(30) Foreign Application Priority Data
Aug. 27, 2010 (KR) 1020100083547

(51) Int. Cl. G06F 3/02

(52) U.S. Cl. 345/168

(57) ABSTRACT

Disclosed herein is a keyboard pad formed to be removed from a touch screen. The keyboard pad is configured to cover a touch screen and include a plurality of protruding portions convexly protruded up to correspond to each key of the keyboard implemented through the touch screen. As a result, the touch feeling and the touch reliability of the keyboard are improved by the protruding portion, thereby providing the keyboard pad for the touch screen for further conveniently performing the text based communications using the terminal.

### CROSS REFERENCE TO RELATED APPLICATION

This application claims the benefit of Korean Patent Application No. 10-2010-0083547, filed on Aug. 27, 2010, entitled “Keyboard Pad For Touch Screen,” which is hereby incorporated by reference in its entirety into this application.

### BACKGROUND OF THE INVENTION

1. Technical Field

The present invention relates to a keyboard pad formed to be removed from a touch screen.

2. Description of the Related Art Generally, a technology has been recently developed to allow a terminal such as a mobile or a PDA to provide short message services (SMS) and perform text-based communication such as e-mail.

Therefore, various terminals including mobiles are provided with a QWERTY type keyboard, meeting a demand of consumers. The QWERTY type keyboard can input texts more rapidly. On the other hand, since the QWERTY type keyboard occupies a large area in the terminal, the size of the screen becomes smaller.

In order to solve the problem, a terminal such as a mobile or a PDA to which a recent technology of the touch screen is applied implements the QWERTY type keyboard through the touch screen, thereby overcoming the disadvantage of the size of the screen being too small.

However, when inputting texts using the QWERTY type keyboard implemented in the touch screen, the textured feeling is poor. That is, since the QWERTY type keyboard is implemented on the touch screen having a flat and smooth feeling, there is no textured feeling of each key or key pressed feeling.

In addition, the reliability of touch is degraded during inputting texts using the QWERTY type keyboard implemented on the touch screen. In other words, when using the QWERTY type keyboard implemented on the touch screen, the accurate position of each key cannot be sensed by the fingertips and even the case where fingers are out of position of the key cannot be sensed by the fingertips, such that an accidental input is frequently input. In addition, in order to implement the QWERTY type keyboard on the touch screen in full size, the size of each key is smaller and the interval between respective keys are narrower, as a result, the error input of the keys frequently occurs.

Meanwhile, the touch screen is applied with a touch technology using a resistive type and a capacitive type.

The resistive touch screen is manufactured to have a structure where a first transparent film formed with a first transparent electrode and a second transparent film formed with a second transparent electrode are opposite to each other, having a dot spacer therebetween. Therefore, when the resistive touch screen is touched by a finger or a pen, coordinates are, for example, recognized by touching the first and second transparent electrodes to each other while the first transparent substrate on the top of the resistive touch screen is bent and sensing the change in a resistive value of the touched portion.

The capacitive touch screen is manufactured to have a structure where a transparent electrode is formed between the first and second transparent films on the top and bottom of the touch screen. Therefore, when the top film is touched by the fingers or a conductive pen, coordinates are recognized by sensing the change in capacitance of the transparent electrode at the touched portion.

### SUMMARY OF THE INVENTION

The present invention has been made in an effort to provide a keyboard pad for a touch screen having an advantage of improving feeling of use of a keyboard implemented on a touch screen and reliability of touch.

A keyboard pad for a touch screen according to a preferred embodiment of the present invention covers a touch screen and includes a plurality of protruding portions convexly protruded to correspond to each key of the keyboard implemented through the touch screen.

The keyboard pad including protruding portions may be made of a transparent and flexible rubber or silicon material.

The protruding portion may be formed corresponding to a QWERTY type keyboard implemented on the touch screen.

The keyboard pad for the touch screen may further include upper and lower electrode plates each disposed on the top and bottom of the protruding portion and connected to each other, penetrating through the protruding portion.

The keyboard pad for the touch screen may further include a spring connecting between the upper and lower electrode plates.

The keyboard pad for the touch screen may further include a removable member disposed on both sides of the keyboard pad to be removed from the touch screen or the terminal including the touch screen.

The removable member may be formed of a band extending from both sides of the keyboard pad and surrounding and fixing the terminal including the touch screen.

### BRIEF DESCRIPTION OF THE DRAWINGS

FIGS. 1 and 2 are perspective views showing a keyboard pad for a touch screen to which the present invention is applied;

FIG. 3 is a cross-sectional view showing a keyboard for a touch screen to which the present invention is applied;

FIG. 4 is an enlarged view of main parts;

FIG. 5 is a cross-sectional view showing another preferred embodiment of a keyboard pad for a touch screen to which the present invention is applied; and

FIG. 6 is a cross-sectional view showing another preferred embodiment of a keyboard pad for a touch screen to which the present invention is applied.

### DESCRIPTION OF THE PREFERRED EMBODIMENTS

Various objects, advantages and features of the invention will become apparent from the following description of embodiments with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. Further, when it is determined that the detailed description of the known art related to the present invention may obscure the gist of the present invention, the detailed description thereof will be omitted.

Hereinafter, preferred embodiments of the present invention will be described in detail with reference to the accompanying drawings.

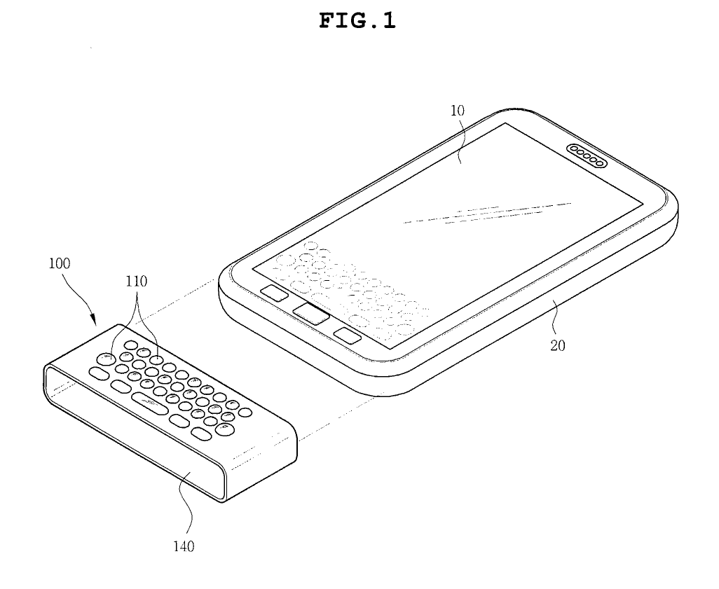

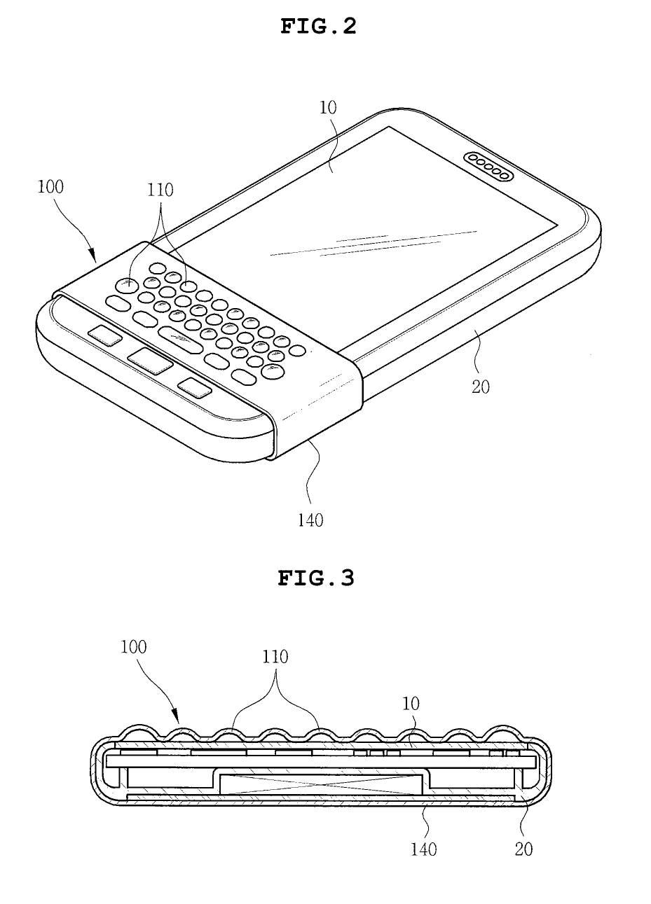

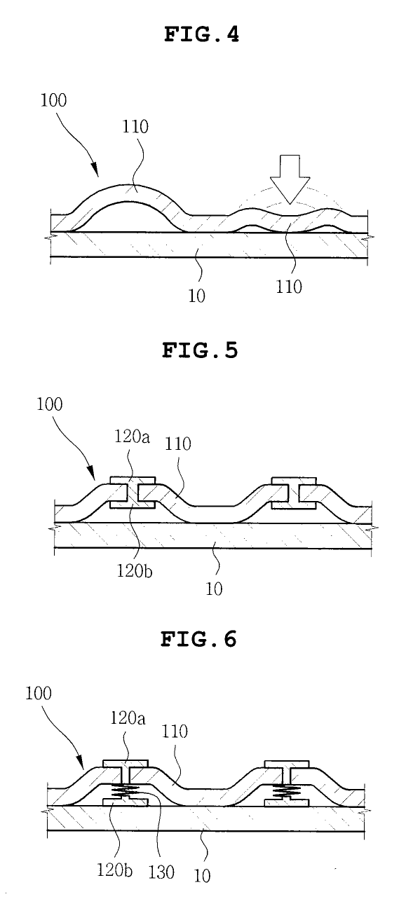

As shown in FIGS. 1 to 4, a keyboard pad 100 for a touch screen of the present invention is configured to cover a touch screen 110 and to include a plurality of protruding portions 110 convexly protruded to correspond to each key of a keyboard implemented through the touch screen.

The keyboard pad 100 flatly formed is adhered to the touch screen 10 and the protruding portion 110 is convexly formed so that the bottom surface thereof is spaced apart from the surface of the touch screen. The protruding portion 110 is convexly protruded in the state where it is spaced apart from the touch screen 10, such that an elastic force is generated when it is pressed by fingers, thereby improving the feeling of use. In this case, the protruding portion 110 is integrally molded together with the keyboard pad 100.

The keyboard pad 100 including the protruding portion 110 is made of a transparent and flexible rubber or silicon material.

The keyboard pad 100 including the protruding portion 110 is made of a transparent material, such that it can be accurately disposed on the keyboard implemented on the touch screen 10 and all screens implemented on the touch screen 10 can be viewed even in the state of covering the touch screen 10 with the keyboard pad 100.

In addition, the keyboard pad 100 including the protruding portion 110 is made of a flexible rubber or silicon material, such that the touch screen 10 can be easily touched by pressing the protruding portion 110 and the protruding portion keeps its own original shape at all times due to its own elastic force when fingers pressing the protruding portion 110 are removed.

The protruding portion 110 is formed corresponding to the QWERTY type keyboard implemented on the touch screen 10 as shown in FIGS. 1 and 2. Forming the protruding portion 110 corresponding to the QWERTY type keyboard is by way of example only. Therefore, the protruding portion 110 may be formed corresponding to the existing used keyboard or all types of keyboards to be used in the future.

The keyboard pad 100 is formed to be applicably used in both the resistive and capacitive touch screens 10.

As the preferred embodiment of the keyboard pad 100 used for the resistive touch screen 10, all the configurations in which the protruding portion 110 is convexly protruded may be used as described above. That is, since the resistive touch screen 10 inputs the keys of the keyboard by contacting the first and second transparent electrodes spaced apart from each other when the upper film is touched as described in the Background Art, it is formed to press the upper film of the touch screen through the protruding portion 110.

As the preferred embodiment of the keyboard pad 100 used for the capacitive touch screen 10, as shown in FIG. 5, it may be configured to include upper and lower electrode plates 120a and 120b that are each disposed on the top and bottom of the protruding portion 110 and connected to each other penetrating through the protruding portion 110.

Since the capacitive touch screen 10 inputs the keys of the keyboard by changing the capacitance of the transparent electrode when the upper film is touched using fingers or the conductive pen as described in the Background Art, the keyboard pad 100 is made of a non-conductive material and is provided with the upper and lower electrode plates 120a and 120b contacting the touch screen, having conductivity, when the protruding portion 110 is touched by the fingers or the conductive pen.

As the preferred embodiment of the upper and lower electrode plates 120a and 120b, a spring 130 connects between the upper and lower electrode plates 120a and 120b as shown in FIG. 6. In this case, the upper electrode plate 120a is fixed to the upper surface of the protruding portion 110 and the lower electrode plate 120b is combined with the tip of the spring 130 to be maintained in the state where it is adhered to the touch screen 10. Therefore, when the upper electrode plate 120a is touched, the touch reliability of the touch screen 10 is improved due to the lower electrode plate 120b.

The upper and lower electrode plates 120a and 120b are made of a transparent material so as not to cover the keyboard implemented on the touch screen 10. The upper and lower electrode plates 120a and 120b made of the transparent material may be made of, for example, a conductive film.

The keyboard pad 100 is configured to include a removable member 140 to be removed from the touch screen 10 or the terminal 20 including the touch screen. That is, the keyboard pad 100 may be conveniently removed from the touch screen 10 by a removable member 140.

The removable member 140 extends from both sides of the keyboard pad 100 is formed in a band for surrounding and fixing the terminal 20 including the touch screen 10. The band as the removable member 140 is by way of example only and all types such as a suction plate capable of removing the keyboard pad 100 from the touch screen 10, an adhesive tape, a case mounted to be inserted into the terminal 20, or the like, may be used in a broad sense.

According to the present invention having the above-mentioned configuration, the feeling of use and the reliability of touch may be further improved by attaching the keyboard pad 100 to the front surface of the touch screen 10 and then, touching the keyboard implemented on the touch screen 10 through the protruding portion 110.

In addition, the keyboard pad 100 is made of a transparent material to conveniently use the keyboard pad, without covering the screen even in the state of covering the touch screen 10.

In addition, the keyboard pad can be conveniently used even in the capacitive touch screen 10 by the upper and lower electrode plates 120a and 120b formed on the top and bottom surfaces of the protruding portion 110.

Further, the keyboard pad is conveniently removed from the touch screen by a removable member 140, such that the use thereof is convenient.

According to the keyboard pad for the touch screen of the present invention, the keyboard pad is attached to the front surface of the touch screen and then, the keyboard implemented on the touch screen is touched through the protruding portion, thereby making it possible to further improve the feeling of use and the reliability of touch.

According to the keyboard pad for the touch screen of the present invention, the keyboard pad is made of a transparent material, thereby making it possible to conveniently use the keyboard pad, without covering the screen even in the state of covering the touch screen.

According to the keyboard pad for the touch screen of the present invention, the keyboard pad can be conveniently used even in the capacitive touch screen by the upper and lower electrode plate formed on the top and bottom surfaces of the protruding portion.

According to the keyboard pad for the touch screen of the present invention, the keyboard pad can be conveniently removed from the touch screen by a removable member, such that the keyboard pad can be conveniently used.

Although the preferred embodiments of the present invention have been disclosed for illustrative purposes, they are for specifically explaining the present invention and thus the keyboard pad for the touch screen according to the present invention are not limited thereto, but those skilled in the art will appreciate that various modifications, additions and substitutions are possible, without departing from the scope and spirit of the invention as disclosed in the accompanying claims.

Accordingly, such modifications, additions and substitutions should also be understood to fall within the scope of the present invention.

What is claimed is:

1. A keyboard pad for a touch screen, wherein it covers a touch screen and includes a plurality of protruding portions convexly protruded to correspond to each key of the keyboard implemented through the touch screen.

2. The keyboard pad for the touch screen as set fort in claim 1, wherein the keyboard pad is made of a transparent and flexible rubber or silicon material.

3. The keyboard pad for the touch screen as set fort in claim 1, wherein the protruding portion is formed corresponding to a QWERTY type keyboard implemented on the touch screen.

4. The keyboard pad for the touch screen as set fort in claim 1, further comprising upper and lower electrode plates each disposed on the top and bottom of the protruding portion and connected to each other, penetrating through the protruding portion.

5. The keyboard pad for the touch screen as set fort in claim 4, further comprising a spring connecting between the upper and lower electrode plates.

6. The keyboard pad for the touch screen as set fort in claim 1, further comprising a removable member disposed on both sides of the keyboard pad to be removed from the touch screen or the terminal including the touch screen.

7. The keyboard pad for the touch screen as set fort in claim 6, wherein the removable member is formed of a band extending both sides of the keyboard pad and surrounding and fixing the terminal including the touch screen.
